(19) United States
(12) Patent Application Publication
(10) Pub. No.: US 2008/0285868 A1
(43) Pub. Date: Nov. 20, 2008

(54) Simple Adaptive Wavelet Thresholding

(76) Inventors: Barinder Singh Rai, Surrey (CA); Jiliang Song, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/750,123

(22) Filed: May 17, 2007

(51) Int. Cl. G06K 9/36

(52) U.S. Cl. 382/240

(57) ABSTRACT

A method for processing an image is described. In the method, image data representing an image into a memory device. The image data is filtered to obtain a plurality of coefficients representing low and high frequency image data. An area of low frequency data corresponding to one of the coefficients is analyzed to identify a degree of edginess of the region. A threshold is obtained, the threshold varying depending on the degree of edginess. If the coefficient is less than the threshold, it is reduced to zero. Wavelet-based image compression can then be performed on the image using the reduced coefficients.

### BACKGROUND OF THE INVENTION

1. Field of the Invention

The present invention relates generally to digital imaging. More particularly, the present invention relates to a method and device for wavelet-based compression of image data.

2. Description of the Related Art

As imaging devices are reduced in size to fit in small form-factor electronics such as cell phones, manufacturers struggle to provide high quality, high-resolution, images using image sensors of increasingly smaller sizes. As the overall size of an image sensor is reduced and the number of pixels increase, each single-pixel sensor element becomes smaller and smaller. A pixel sensor element is the portion of an image sensor that detects light for one pixel of an image. As pixel sensor elements reduce in size, they collect less light, and therefore require greater amplification, which results in increased noise, particularly in darker environments. A pixel sensor is referred to as “noisy” when the intensity value measured by the sensor has a relatively large random component. In extreme cases, noise is observable in the overall image as a snowy or speckled effect, which is generally undesirable.

The wavelet transform is known for image processing and image compressing. For example, wavelet-based image compression algorithms such as JPEG 2000 have significant advantages over the more common block-based compression algorithms such as JPEG. A prominent advantage of wavelet-based compression algorithms is that they allow a high quality high resolution image to be compressed to a much smaller amount of data than the previous block-based algorithms. A further advantage of wavelet-based image compression algorithms is that, at higher compression ratios, they tend to have a smoothing effect that can be used to remove noise from an image.

Initially, digital images are represented as a matrix of pixels, each pixel having associated color and intensity values. The values themselves may depend on the encoding format of the image. For instance, in RGB-formatted image data, the color is defined by intensity values of red, green, and blue, components of light that make up the color. In YUV-formatted image data, the color of each pixel is defined by luminance (brightness) and two chrominance channels, which together define the color. YUV-formatted images have many advantages over RGB, and is for that reason a very common encoding scheme for color images. For example, YUV-formatted images have a larger color gamut. In addition, by reducing the resolution of the chrominance channels, images can be represented with less information without a perceivable difference to the human eye, since the eye is more sensitive to the higher resolution luminance channel.

A discrete wavelet transform (DWT) algorithm is used to decompose image data, typically formatted in a YUV format, but any format is possible, to bands of coefficients, each band containing coefficients representing high frequency data and low frequency data. The coefficients can then be decoded back into pixel color and intensity values. When image data is decomposed using a DWT, it is filtered using a low-pass (averaging) filter and a high-pass (detail-producing) filter to generate the coefficients representing the high frequency and low frequency data. In regions of an image that contains a small amount of detail, such as a solid blue sky or wall, there may be long strings of very low coefficient values for coefficients representing low frequency data. These long strings of coefficients can be changed to zero, thereby eliminating noise without substantially affecting the quality of the image in any other way. Then, the long strings of zeros can be stored in much less space than they originally occupied.

Noise removing algorithms based on DWTs are superior to previous noise reduction algorithms, which traditionally resulted in blurring the image and a smoothing out of the details. The process of eliminating low-valued coefficients is referred to herein as thresholding.

The low frequency data, which represents an image having one half the number of pixel rows and columns as the original image, can be further filtered by low-pass and high-pass filters, generating a sub-band of coefficients. The coefficients representing high-frequency data of the sub-band can also be subjected to thresholding to further reduce the memory requirements of the compressed image. This process may be repeated in a recursive manner until a 2×2 matrix of wavelet coefficients remain.

There are many variations on how to determine an appropriate threshold value. The threshold must be large enough to remove noise but not so large as to substantially affect details in the image. In one solution used to eliminate noise, the wavelet transform is calculated and the coefficients are ordered by increasing frequency to obtain an array containing the time series average plus a set of coefficients of length 1, 2, 4, 8, etc. The noise threshold is then calculated on the highest frequency spectrum. The median absolute deviation of the highest coefficient spectrum (HH1 for images) is calculated. The median is calculated from the absolute value of the coefficients using the equation:

$${\partial }_{mad} = \frac{\text{median} \{ \vert {c}_{0} \vert , \vert {c}_{1} \vert , … \vert {c}_{{2}^{n - 1} - 1} \vert \}}{0.6745}$$

where c₀, c₁, etc., are the coefficients. The factor 0.6745 rescales the numerator so ⊥_{mad} is also a suitable estimator for the standard deviation for Gaussian white.

The noise threshold is then calculated by τ=∂_{mad} \sqrt{ln(N)}, where N is the number of pixels in the image. The threshold can be applied as a hard threshold, in which case any coefficients less than or equal to the threshold are set to zero, or a soft threshold, in which case the coefficients less than or equal to the threshold are set to zero, but the threshold is also subtracted from any coefficient greater than the threshold. Soft thresholding not only smoothes out the time series, but moves it towards zero.

Typically, small battery-powered digital imaging devices such as video or still cameras, and devices incorporating such cameras, such as cell phones, personal digital assistants (PDAs), etc., lack the processor and memory requirements to add digital filter effects such as noise reduction. Finding the median value involves a computationally intensive sorting of N components. For example, sorting N components using a bubble sort algorithm requires approximately N²/2 operations and using a merge sort requires N log₂N operations. In addition, the sorting needs the same amount of memory to hold the sorted data as swell as a frame buffer to store the highest frequency wavelet coefficients (HH part). Therefore, calculation of the threshold value according to the formula above would consume processor cycles and memory of limited power devices, which in turn would result in shortened battery life and inconvenience to the user, who would have to wait for the processing to complete before viewing or storing the resulting image.

To overcome these limitations, thresholding has therefore been performed limited power imaging devices using an arbitrary global threshold value. The use of an arbitrary global threshold value provides adequate results for most purposes, but does not provide the best results in all parts of a specific image. For example, in some instances, noise can be seen in “quiet” regions of an image while smoothing out of details can be seen in other regions of an image.

Thus, the problem of providing high quality, high resolution images in limited power imaging devices without large memory and processing requirements has not been adequately addressed prior to the present invention.

### SUMMARY OF THE INVENTION

Broadly speaking, the present invention fills these needs by providing a digital imaging device and method providing digital filter effects.

It should be appreciated that the present invention can be implemented in numerous ways, including as a process, an apparatus, a system, a device, or a method. Several inventive embodiments of the present invention are described below.

In one embodiment, a method for processing an image is provided. In the method, image data representing an image is received into a memory device. The image data is filtered to obtain a first plurality of coefficients representing low frequency image data and a second plurality of coefficients representing high frequency image data. For each coefficient of the second plurality of coefficients a degree of edginess of a region of the image corresponding to the coefficient is determined, the degree of edginess being a value representing an amount of variation in the region as represented by the first plurality of coefficients; a threshold for the coefficient is obtained, the threshold varying depending on the degree of edginess of the region corresponding to the coefficient; and the coefficient is compared with the threshold. The coefficient is reduced to zero when the coefficient is less than the threshold. The image data is then compressed using the reduced coefficients of the second plurality of coefficients.

In another embodiment, a method for processing an image is provided. Initially, image data representing an image is received into a memory device. A discrete wavelet transformation algorithm is applied to the image data to decompose the image data to a plurality of coefficients representing high frequency image data and low frequency image data. For each coefficient of the low frequency image data, a degree of edginess of the image at an area of the image corresponding to the coefficient is determined, the degree of edginess being a measure of an amount of color or brightness variation of pixels represented by the low frequency image data; a threshold is obtained, the threshold having a value that varies depending on the degree of edginess; and the coefficient is reduced to zero when the coefficient is less than the threshold. Wavelet-based image compression is performed on the image using the reduced coefficients. The image data is stored in a compressed data format into the memory device.

In yet another embodiment, an encoding device having data-driven logical circuits formed into a chip is provided. The logical circuits are configured to perform a plurality of operations. Initially, image data is filtered to obtain a first plurality of coefficients representing low frequency image data and a second plurality of coefficients representing high frequency data. For each coefficient of the plurality of coefficients, the logical circuits determine a degree of edginess of a region of the image corresponding to the coefficient, the degree of edginess being a value representing an amount of color variation of the low frequency image data in a region of the image data corresponding to the coefficient; obtain a threshold for the coefficient, the threshold varying depending on the degree of edginess of the region corresponding to the coefficient; and compare the coefficient to the threshold. The coefficient is reduced to zero when the coefficient is less than the threshold. Wavelet-based image compression is performed on the image data using the reduced coefficients and the image is stored in a compressed data format into a computer readable medium.

### BRIEF DESCRIPTION OF THE DRAWINGS

The present invention will be readily understood by the following detailed description in conjunction with the accompanying drawings, and like reference numerals designate like structural elements.

FIG. 1 shows a schematic overview of an imaging device.

FIG. 2 shows functional elements of an exemplary graphics controller of the imaging device of FIG. 1.

FIG. 3a shows a flowchart depicting an exemplary procedure for processing image data.

FIG. 3b shows an exemplary graph relating an edge factor value to a threshold value.

FIG. 4 shows a flowchart describes by way of example a simple procedure to determine whether a low frequency coefficient relates to an edge region of the image.

FIG. 5 shows a coefficient matrix to assist in the explanation of the procedure described by the flowchart of FIG. 4.

### DETAILED DESCRIPTION

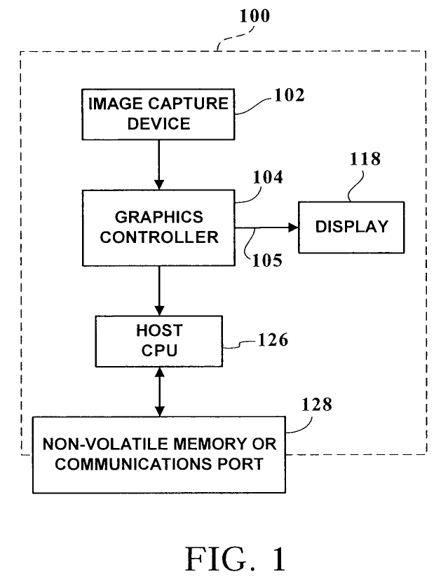

FIG. 1 shows a schematic overview of an imaging device 100. Imaging device 100 may be a digital camera, digital video recorder, or some electronic device incorporating a digital camera or video recorder, such as, for example, a personal digital assistant (PDA), cell phone or other communications device, etc. Imaging device 100 includes a graphics controller 104, a host central processing unit (CPU) 126, a display 118, and an image capture device 102. Graphics controller 104 provides an interface between display 118, host CPU 126, and image capture device 102.

The timing control signals and data lines, such as line 105 communicating between graphics controller 104 and display 118, are shown as a single line but may in fact be several address, data, and control lines and/or a bus. All communication lines shown in the figures will be presented in this manner to reduce the complexity and better present the novel aspects of the invention.

Host CPU 126 performs digital processing operations and communicates with graphics controller 104. Host CPU is also in communication with non-volatile memory (NVM) or communication port 128. NVM or communications port 128 may be internal NVM such as flash memory or other EEPROM, or magnetic media. Alternatively, NVM or communications port 128 may take the form of a removable memory card such as that widely available and sold under such trademarks as “SD RAM,” “Compact Flash”, and “Memory Stick”. NVM or communications port 128 may also be any other type of machine-readable removable or non-removable media, including, for example USB storage, flash-memory storage drives, and magnetic media. Finally, non-volatile memory or communications port 128 may be a communications port to some external storage device or destination. For example, if digital imaging device is a communications device such as a cell phone, non-volatile memory or communications port 128 may represent a communications link to a carrier, which may then store data on hard drives as service to customers, or transmit the data to another cell phone.

Display 118 can be any form of display capable of displaying an image. Generally, display 118 will comprise a liquid crystal display (LCD). However, other types of displays are available or may become available that are capable of displaying an image. Although image capture device 102 and display 118 are presented as being part of digital imaging device 100, it is possible that one or both of image capture device 102 and display 118 are external to or even remote from each other and/or graphics controller 104. For example, if digital imaging device is a security camera or baby monitor, for instance, it may be desirable to provide a display 118 remote from the image capture device 102 to provide monitoring capability at a remote location.

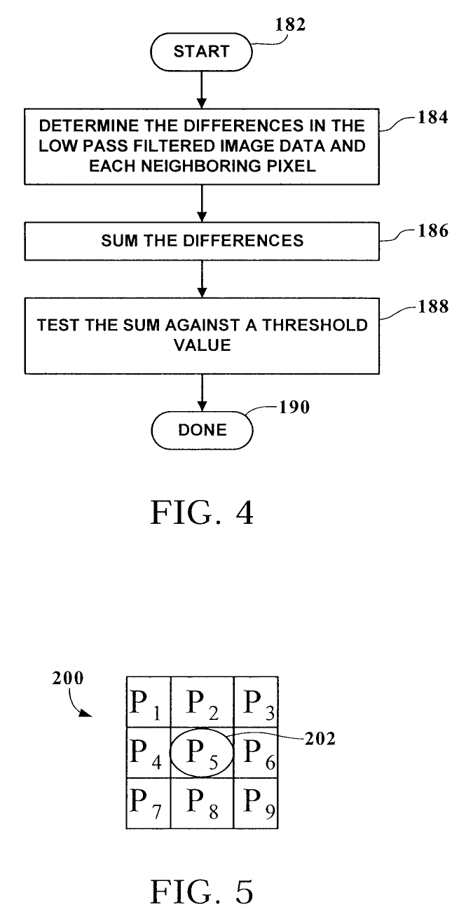

Image capture device 102 may include a charged coupled device or complementary metal oxide semiconductor type sensor having varying resolutions depending upon the application. In one embodiment, image capture device 102 includes a color sensor containing a two-dimensional array of pixel sensors in which each pixel sensor has a color filter in front of it in what is known as a color filter array (CFA). One common type of CFA is the Bayer filter in which every other pixel has a green filter over it in a checkerboard pattern, with remaining pixels in alternate rows having blue and red filters. An exemplary Bayer filter layout is shown in FIG. 4, which will be discussed in further detail below. When the color sensor reads out data from image capture device 102, the data is referred to as “raw image data” which may, for example, describe a single two-dimensional array of pixels containing information for all three primary colors of red, green, and blue. This contrasts with RGB data which describes three two-dimensional arrays, or “planes” of pixels: one plane for red pixels, one plane for blue pixels, and one plane for green pixels.

Raw image data is transmitted from image capture device 102 to graphics controller 104 which may then provide image data to display 118 or host CPU 126. As mentioned previously, display 118 is any type of display capable of displaying an image. Typically, this will be an LCD display for small hand-held devices, although other types of displays such as plasma displays, organic light emitting diodes, electronic paper, and cathode ray tubes may be used as well.

In one embodiment, image capture device 102 captures data at several frames per second, e.g., 15 frames per second, which are displayed on display 118 to provide a preview prior to committing an image to NVM or communications port 128. When the user is happy with a particular composition, he or she causes the image to be sent to NVM or communications port 128, e.g., by pressing a button (not shown). It is also possible to store a plurality of frames in quick succession to create a video.

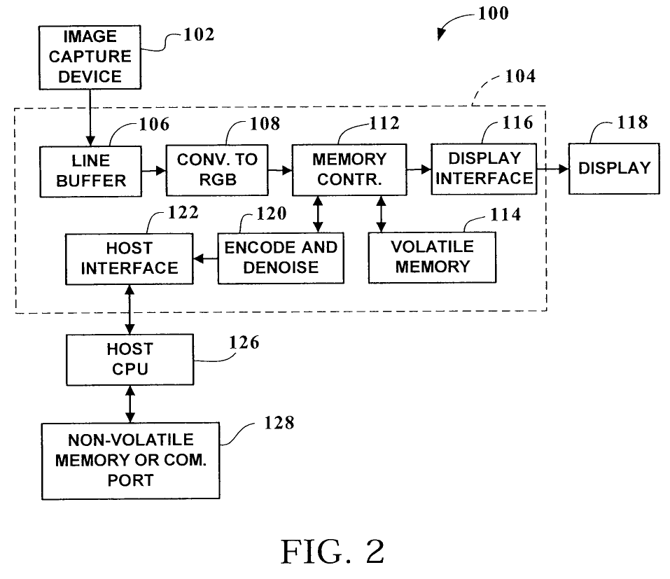

Referring now to FIG. 2, an exemplary graphics controller 104 comprises a number of processing elements schematically represented as a series of blocks describing their function. In this embodiment, raw image data from image capture device 102 is first received in a line buffer 106. Image data converter 108 reads the raw image data and outputs RGB data.

Memory controller 112 receives RGB data from converter 108 and temporarily stores the RGB data in volatile memory 114. Memory controller 112 also makes this RGB data available to display interface 116 and to host interface 122 via encoder 120.

Display interface 116 includes timing circuits and or other circuitry necessary for displaying the image represented by the RGB data on display 118. In one embodiment, display interface 116 includes a frame buffer. In another embodiment, volatile memory 114 performs the function of a frame buffer. In yet another embodiment, display 118 includes random-access memory and does not require an external frame buffer. Display 118, upon receiving display data from display interface 116 displays the image for the user to view. In a preview mode, this view is generally a live, real-time image captured a definite period of time from the moment image capture device 102 captured the image. Typically, this definite period of time will be a fraction of a second, and may be refreshed a number of times a second, e.g., 15 times a second, to provide a preview image to the user of exactly what the image will look like if committed to NVM or communications port 128. The preview image may have a resolution that is much less than the native resolution of image capture device 102.

At some point, the user may decide that a picture is properly composed and may want to store a high resolution image for later viewing or to transmit the image to a friend. The user then interacts with imaging device, e.g., presses a button (not shown), to generate an image that can be saved for later use or transmitted to a friend. Host CPU 126 will respond to this event by instructing graphics controller 104 to retrieve a high-resolution image and store it in volatile memory 114, from which host CPU 126 may retrieve the image by way of encoder and noise filter 120. Memory controller 112 will send the RGB data stored in volatile memory 114 to encoder 120. Encoder 120 may filter the image to reduce noise and compress the image into a compressed image format, e.g., one of the well-known JPEG or JPEG-2000 formats, and pass the compressed image data to host interface 122 which provides it to Host CPU 126. Host CPU 126 may then store the image or transmit the image using NVM or communications port 128.

Although encoder 120 is shown as being part of graphics controller 120, it can also exist separately from graphics controller 120 and retrieve image data from volatile memory 114 by way of host interface 122.

In one embodiment, encoder 120 performs compression and simultaneously removes noise from the image data using a discrete wavelet transformation (DWT). In another embodiment, the resulting compressed image data is formatted in conformance with the JPEG2000 standard, although other file formats can be used.

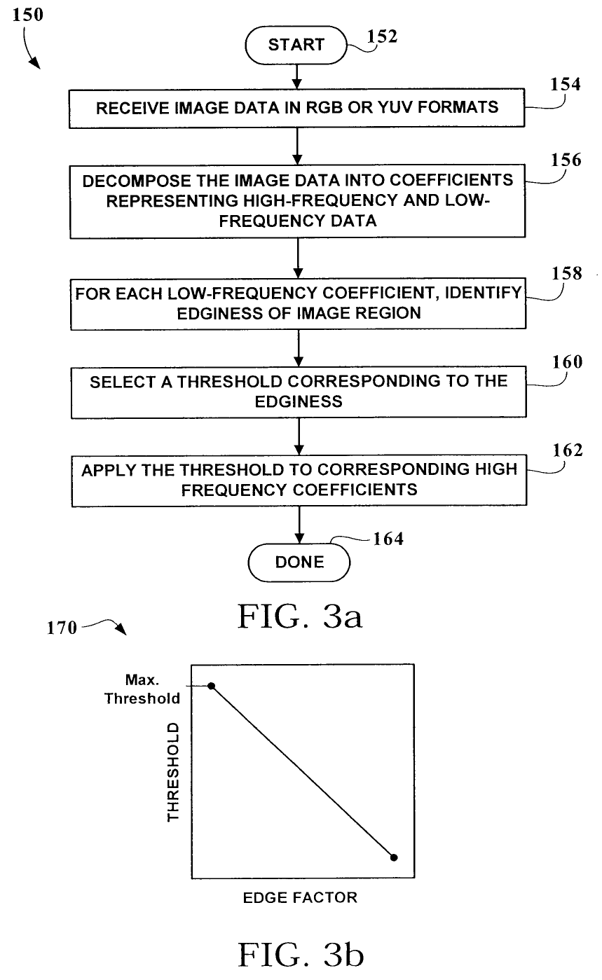

FIG. 3a shows a flowchart 150 depicting an exemplary procedure for processing image data from volatile memory 114 to compress and remove noise from the image represented by the image data. The procedure begins as indicated by start block 152 and flows to operation 154 wherein image data is received in RGB or YUV formats. As mentioned previously, other formats are possible, and, depending on the file format being generated, YUV formatted image data may be required. If the image is provided in a different format, e.g., a raw format generated by an image sensor, then the image data can be compressed and denoised in the raw format or it can be first converted into a different format. For example, referring to FIG. 2, if imaging device lacks a display 118, then conversion to RGB format may be unnecessary. In this case, the image data may be directly compressed, or converted to YUV format prior to being stored in volatile memory 114. Some formats, e.g., JPEG2000, may require that the image data first be converted to a YUV format prior to applying the DWT algorithm.

Referring back to FIG. 3a, after receiving the image data in a volatile memory, the procedure flows to operation 156 wherein the image data is decomposed into coefficients representing high-frequency and low-frequency image data. For example, the image data may be passed through a high pass filter and a low-pass filter. It should be noted that for DWT image compression formats such as JPEG2000, the image data may be passed through a high pass filter and low pass filters, including a high pass filter in horizontal, vertical, and diagonal directions. Adaptive thresholding as described below is performed on the high pass image data, represented by a series of coefficients representing high frequency image data. Other aspects of the image compression are performed as generally known and understood in the arts of wavelet-based image compression.

After passing the image data through the low-pass filter, the procedure flows to operation 158 wherein each coefficient representing low-frequency image data is analyzed to see if the corresponding pixel is on or near i.e., at, an edge in operation 158. An edge is defined as a boundary between two colors or intensity values. For example, an object of one color or brightness may be positioned in front of or against a background of a different color or brightness generates an edge at the interface between the object and the background. Furthermore, an amount of edginess of the boundary may be determined. A boundary is edgier when there is greater color variation of surrounding pixels, e.g., a hard boundary between a tree branch and the sky would be edgier than a soft boundary formed by an out of focus tree branch or a cloud. In one embodiment, a determination is made as to whether the pixel is on an edge or not, in which case a binary true or false value may be returned. In another embodiment, an edge factor representing a degree of edginess may be computed. An exemplary method for calculating an edge factor representing an edginess amount is described below with reference to FIGS. 4 and 5.

In operation 160, a threshold corresponding to the identified level of edginess is selected. In one embodiment, the threshold is a first value when the coefficient relates to an edge region, and a second value when the coefficient relates to a non-edge region. In this case the edginess may be provided as a binary true or false value. In another embodiment, the threshold is computed from an edge factor, which indicates a degree of edginess of the image region corresponding to the coefficient. For example, the greater the degree of edginess, lower threshold values may be selected.

In one embodiment, a maximum threshold value is selected based on user input, e.g., based on an image capture mode set by a user. Exemplary image capture modes include, sunny/outdoor, indoor, night-time. Each user mode of an electronic imaging device may therefore be pre-configured to apply a different maximum threshold value. Alternatively, the user may be permitted to manually select a maximum threshold value. A simple linear relation can be created to obtain a threshold value to compare with a high frequency coefficient based on the edge factor of the corresponding low frequency coefficient. FIG. 3b shows a graph 170 plotting the edge factor on the x-axis and an output threshold value on the y-axis. Thus, the output threshold value may be obtained by simple arithmetic or by using a lookup table. For example, for N threshold values, N−1 lower threshold values may be calculated by dividing M by N and subtracting the quotient repeatedly from M. Thus, if N=2 and the maximum threshold value is 5.4, then the first threshold value is 5.4 and the second threshold value is 2.7. If N=4, then threshold values are 5.4, 5.4−1.35 (4.05), 4.05−1.35 (2.7), and 2.7−1.35 (1.35).

After obtaining a threshold corresponding to the identified level of edginess, the procedure flows to operation 162 wherein the threshold value is applied to the high frequency coefficient. That is, the coefficient is reduced to zero if it is less than or equal to the threshold. If the coefficient is greater than the threshold it is either left at its original value for hard thresholding or reduced by the amount of the threshold for soft thresholding of the image data. After applying the threshold in operation 162, the thresholding procedure ends as indicated by done block 164. It should be recognized that the order of operations may be manipulated. For example, operations 158 through 162 may be repeated for each pixel of the decomposed image, wherein a first pixel at the upper left corner of the image is selected, the edginess identified, the corresponding threshold obtained, and then applied, and then a next pixel in the row is selected and the process repeated. After the first line is processed, each subsequent line is similarly processed. In another embodiment, a degree of edginess is determined for each pixel of the image before translating the degree of edginess to a threshold amount for each pixel, then the thresholds are applied to the high-frequency coefficients. While this latter embodiment requires additional resources, it may be preferable since it lends itself to increased parallelism or pipelining of the image processing data, and therefore faster processing. After thresholding, the procedure ends as indicated by done block 164, however, additional processing of the image data may be performed in accordance with known DWT and image compression algorithms. For example, additional sub-bands of coefficients can be generated by further decomposing the low-frequency coefficient data, as generally known in the field of image compression. FIG. 4 shows a flowchart 180 describes by way of example a simple procedure to determine a degree of edginess of an image region corresponding to a low frequency coefficient. In one embodiment, the degree of edginess is represented by an edge factor, which is simply a value that identifies the degree of edginess of the image region. In another embodiment, the degree of edginess is simply a binary true or false value, that represents whether the image region is at an edge within the image or not, the edge being a boundary between two different colors or brightnesses.

The procedure begins as indicated at start block 182 and flows to operation 184 wherein the numerical differences between each surrounding coefficient and the coefficient being tested is calculated. Then in operation 186, the absolute values of the differences are summed. For example, referring to FIG. 5, a coefficient P5 202 is being tested to determine if it lies at an edge. The following calculation is then performed: EF=|P₅−P₁|+|P₅−P₂|+|P₅−P₃|+|P₅−P₄|+|P₅−P₆|+|P₅−P₇|+|P₅−P₈|+|P5−P₉|, where EF refers to an edge factor. Edge factor EF provides a value representing a degree of edginess of the region of the image represented in FIG. 5. In this case, the region is a 3×3 matrix of pixels. However, other sized regions can also be tested in the same manner. Large values of EF indicate that P₅ is at an edge whereas low values of EF suggest that P₅ is not on an edge. It should be noted that the calculation described above may be simplified depending on the implementation. For example, in one embodiment, coefficients P₂, P₄, P₆ and P₈ may be omitted from the calculation. If the pixel being tested is at the top, bottom, or left- or right-most edge of the image, than the top row, bottom row, left column, or right column, respectively, may be repeated to generate the matrix shown in FIG. 5.

To obtain a binary true or false value indicating whether a pixel is at an edge or not, the operation 188 may be performed. In operation 188, the sum calculated in operation 186, which is the edge factor, is compared with an arbitrary edge factor threshold. The actual value of the edge factor threshold may depend on the format, e.g., color depth, of the image. If the edge factor is less than the edge factor threshold then the pixel corresponding to the coefficient P₅ does not lie at an edge. On the other hand, if the edge factor is greater than the edge factor threshold, then the pixel corresponding to coefficient P₅ lies at an edge. As noted, generation of a binary true or false value is optional depending on the implementation. The procedure then ends as indicated by done block 196.

In contrast to prior threshold calculations, the 3×3 adaptive threshold described above with reference to FIGS. 3a and 4 requires only eight subtractions, eight additions, and about four simple comparisons for every pixel in the averaged image (the LL part). In totality, it requires only about 20 calculations for every pixel and does not require extra memory as was the case with previous techniques.

It will be recognized by those skilled in the art that the graphics controller is a data driven hardware device, such as an application specific integrated circuit (ASIC) or a field programmable gate array (FPGA). The operation of such devices is driven by data, not necessarily by software instructions. In one embodiment, the operations described above with reference to FIGS. 3 and 4 are performed by such data-driven hardware devices. The operations are not necessarily performed sequentially as might be suggested by flowcharts 150, 180. Thus, many operations may be performed in parallel and/or in a different order than presented above. Furthermore, there may be instances where a particular operation is combined with other operations such that no intermediary state is provided. Likewise various operations may be split into multiple steps with one or more intermediary states. Graphics controller 104 (FIGS. 1, 2) and other hardware devices incorporate logic typically designed using a hardware description language (HDL) or other means known to those skilled in the art of integrated circuit design. The generated circuits will include numerous logic gates and connectors to perform various operations and does not rely on software instructions. It is also possible to implement the procedures described above in software for execution on a processing device.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion. In addition, the invention may be encoded in an electromagnetic carrier wave in which the computer code is embodied.

Embodiments of the present invention can be processed on a single computer, or using multiple computers or computer components which are interconnected. A computer, as used herein, shall include a standalone computer system having its own processor(s), its own memory, and its own storage, or a distributed computing system, which provides computer resources to a networked terminal. In some distributed computing systems, users of a computer system may actually be accessing component parts that are shared among a number of users. The users can therefore access a virtual computer over a network, which will appear to the user as a single computer customized and dedicated for a single user.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for processing an image, the method comprising method operations of:
receiving image data representing an image into a memory device;
filtering the image data to obtain a first plurality of coefficients representing low frequency image data and a second plurality of coefficients representing high frequency image data;
for each coefficient of the second plurality of coefficients:
determining a degree of edginess of a region of the image corresponding to the coefficient, the degree of edginess being a value representing an amount of variation in the region as represented by the first plurality of coefficients;
obtaining a threshold for the coefficient, the threshold varying depending on the degree of edginess of the region corresponding to the coefficient; and
comparing the coefficient to the threshold and reducing the coefficient to zero when the coefficient is less than the threshold; and
compressing the image data using the reduced coefficients of the second plurality of coefficients and storing the image data in a compressed data format on a computer readable medium.

2. The method of claim 1, wherein the degree of edginess comprises a binary true or false value indicating whether the coefficient lies at an edge region, the method further comprising:when the coefficient corresponds to the edge region, reducing the coefficient to zero when the coefficient is less than a first threshold; and
when the coefficient corresponds to a region outside the edge region, reducing the coefficient to zero when the coefficient is greater than a second threshold, the second threshold being greater than the first threshold.

3. The method of claim 1, wherein the image data received is in a YUV encoded format.

4. The method of claim 1, wherein the memory device comprises a frame buffer of a graphics controller, and the method operations are performed using data-driven hardware logic gates.

5. The method of claim 1, wherein the determining of the degree of edginess comprises
calculating an edge factor, the edge factor being a sum of absolute values of differences between the coefficient and a plurality of neighboring coefficients.

6. The method of claim 1, further comprising method operations of:
capturing the image using an image sensor, the image sensor generating raw image data;
converting the raw image data into the image data; and
displaying the image on a display screen.

7. The method of claim 1, further comprising reducing the coefficient by an amount of the threshold when the coefficient is greater than the threshold.

8. A method for processing an image, the method comprising method operations of:
receiving image data representing an image into a memory device;
applying a discrete wavelet transformation algorithm to decompose the image data to a plurality of coefficients representing high frequency image data and low frequency image data;
for each coefficient of the plurality of coefficients representing the low frequency image data:
determining a degree of edginess of the image at an area of the image corresponding to the coefficient, the degree of edginess being a measure of an amount of color or brightness variation of pixels represented by the low frequency image data;
obtaining a threshold, the threshold having a value that varies depending on the degree of edginess; and
reducing the coefficient to zero when the coefficient is less than the threshold; and
performing wavelet-based image compression on the image using the reduced coefficients and storing the image in a compressed data format into the memory device.

9. The method of claim 8 further comprising:
determining that the coefficient corresponds to an edge region when it has a degree of edginess above a selected threshold;
when the coefficient corresponds to the edge region, reducing the coefficient to zero when the coefficient is less than a first threshold; and
when the coefficient corresponds to a region outside the edge region, reducing the coefficient to zero when the coefficient is less than a second threshold, the second threshold being greater than the first threshold.

10. The method of claim 8, wherein the image data received is in a YUV encoded format.

11. The method of claim 8, wherein the memory device comprises a frame buffer of a graphics controller, and the method operations are performed using data-driven hardware logic gates.

12. The method of claim 8, wherein the step of determining the degree of edginess comprises:
calculating an edge factor, the edge factor being a sum of absolute values of differences between the coefficient and a plurality of neighboring coefficients.

13. An encoding device having data-driven logical circuits formed into a chip, the logical circuits being configured to perform operations including:
filtering image data to obtain a first plurality of coefficients representing low frequency image data and a second plurality of coefficients representing high frequency data;
for each coefficient of the plurality of coefficients:
determining a degree of edginess of a region of the image corresponding to the coefficient, the degree of edginess being a value representing an amount of color variation of the low frequency image data in a region of the image data corresponding to the coefficient;
obtaining a threshold for the coefficient, the threshold varying depending on the degree of edginess of the region corresponding to the coefficient; and
comparing the coefficient to the threshold and reducing the coefficient to zero when the coefficient is less than the threshold; and
performing wavelet-based image compression on the image using the reduced coefficients; and
storing the image in a compressed data format into a computer readable medium.

14. The encoding device of claim 13, wherein the encoding device resides on a graphics controller chip, the graphics controller chip including a memory controller, a volatile memory storage device for storing the image data, a display interface and a host interface.

15. The encoding device of claim 13, the logical circuits being further configured to reduce the coefficient by an amount equal to the threshold when the coefficient is greater than the threshold.

16. The encoding device of claim 13, wherein the image data received is in a YUV encoded format.

17. The encoding device of claim 14, wherein the memory storage device comprises a frame buffer of a graphics controller, and the circuitry implements data-driven hardware logic gates.

18. The encoding device of claim 13, wherein the degree of edginess is determined by calculating an edge factor, the edge factor being a sum of the absolute values of the differences between the coefficient and a plurality of neighboring coefficients.

19. The encoding device of claim 13, wherein the encoding device resides on a graphics controller chip, the graphics controller chip including a line buffer for receiving raw image data from an image sensor; an image encoder for converting the raw image data to RGB-formatted image data; a memory controller and a frame buffer for storing the RGB-formatted image data, and a display interface for displaying an image based on the RGB-formatted image data.
